(19) United States
(12) Patent Application Publication
(10) Pub. No.: US 2024/0063563 A1
(43) Pub. Date: Feb. 22, 2024

(54) SHEET-LIKE CONDUCTIVE PATH

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pipatthana PHATIWUTTIPAT, Mie (JP); Kenji MAKINO, Mie (JP)

(21) Appl. No.: 18/270,797

(22) PCT Filed: Dec. 17, 2021
(86) PCT No.: PCT/JP2021/046839

§ 371 Date: Jul. 3, 2023

(30) Foreign Application Priority Data
Jan. 5, 2021 (JP) 2021-000372

(51) Int. Cl. H01R 12/77; H01R 13/42; H01R 43/20

(52) U.S. Cl. CPC H01R 12/778; H01R 13/42; H01R 43/205; H01R 12/65

(57) ABSTRACT

It is aimed to enable a plurality of terminal fittings to be fixed to a sheet-like flexible conductive member while being positioned. A sheet-like conductive path is provided with a plurality of first terminal fittings (20), a plurality of second terminal fittings (30), a sheet-like flexible conductive member (11) to be fixed to the plurality of first terminal fittings (20) and the plurality of second terminal fittings (30), a positioning portion (41) for positioning the plurality of first terminal fittings (20) and the plurality of second terminal fittings (30) in a state where the plurality of first terminal fittings (20) and the plurality of second terminal fittings (30) are not fixed to the sheet-like flexible conductive member (11), and a housing (50) for accommodating the plurality of first terminal fittings (20) and the plurality of second terminal fittings (30) fixed to the sheet-like flexible conductive member (11).

### TECHNICAL FIELD

The present disclosure relates to a sheet-like conductive path.

### BACKGROUND

Patent Document 1 discloses a connector in which a plurality of terminal fittings are fixed to an end part of a flexible flat cable while being arranged in parallel. The plurality of terminal fittings are individually accommodated in a plurality of cavities formed in a housing.

### PRIOR ART DOCUMENT

### Patent Document

Patent Document 1: JP 2003-203740 A

### SUMMARY OF THE INVENTION

### Problems to be Solved

To smoothly insert the plurality of terminal fittings fixed to the flexible flat cable into the plurality of cavities, the plurality of terminal fittings need to be positioned in an arrangement direction. Particularly, in the case of reducing the size of the connector, clearances between the cavities and the terminal fittings become narrower. Thus, positioning accuracy between the terminal fittings has to be enhanced. However, since the flexible flat cable is not formed with a part for positioning the terminal fittings, it is difficult to position the plurality of terminal fittings on the flexible flat cable with high accuracy.

A sheet-like conductive path of the present disclosure was completed on the basis of the above situation and aims to enable a plurality of terminal fittings to be fixed to a sheet-like flexible conductive member while being positioned.

### Means to Solve the Problem

The present disclosure is directed to a sheet-like conductive path with a plurality of terminal fittings, a sheet-like flexible conductive member to be fixed to the plurality of terminal fittings, a positioning portion for positioning the plurality of terminal fittings in parallel in a state where the plurality of terminal fittings are not fixed to the sheet-like flexible conductive member, and a housing for accommodating the plurality of terminal fittings fixed to the sheet-like flexible conductive member.

### Effect of the Invention

According to the present disclosure, a plurality of terminal fittings can be fixed to a sheet-like flexible conductive member while being positioned.

### BRIEF DESCRIPTION OF THE DRAWINGS

FIG. 1 is a perspective view of a sheet-like conductive path of one embodiment.

FIG. 2 is a perspective view showing a state where a conductive path module and a housing are separated.

FIG. 3 is an exploded perspective view of the conductive path module.

FIG. 4 is a side view in section of the sheet-like conductive path.

FIG. 5 is a plan view in section of the sheet-like conductive path.

### DETAILED DESCRIPTION TO EXECUTE THE INVENTION

### Description of Embodiments of Present Disclosure

First, embodiments of the present disclosure are listed and described.

(1) The sheet-like conductive path of the present disclosure is provided with a plurality of terminal fittings, a sheet-like flexible conductive member to be fixed to the plurality of terminal fittings, a positioning portion for positioning the plurality of terminal fittings in a state where the plurality of terminal fittings are not fixed to the sheet-like flexible conductive member, and a housing for accommodating the plurality of terminal fittings fixed to the sheet-like flexible conductive member. Since the sheet-like conductive path of the present disclosure is provided with the positioning portion capable of positioning the plurality of terminal fittings in a state before the plurality of terminal fittings are fixed to the sheet-like flexible conductive member, the plurality of terminal fittings can be fixed to the sheet-like flexible conductive member while being positioned.

(2) Preferably, the positioning portion is capable of positioning the plurality of terminal fittings with fixing portions of the plurality of terminal fittings to the sheet-like flexible conductive member exposed, and the sheet-like flexible conductive member and the plurality of terminal fittings are fixed by soldering portions. According to this configuration, the terminal fittings and the sheet-like flexible conductive member can be fixed by reflow soldering or flow soldering.

(3) Preferably, the positioning portion is formed in a holding member separate from the housing and made of a material higher in heat resistance than the housing. According to this configuration, the plurality of terminal fittings positioned by the positioning portion can be fixed to the sheet-like flexible conductive member by reflow soldering.

(4) Preferably, the positioning portion is formed in a holding member separate from the housing, and the holding member is formed with a locking portion for locking the sheet-like flexible conductive member. According to this configuration, the plurality of terminal fittings and the sheet-like flexible conductive member can be positioned.

(5) Preferably, fixing portions of the plurality of terminal fittings and the sheet-like flexible conductive member are accommodated in the housing. According to this configuration, it is possible to prevent the interference of an external matter with the fixing portions of the plurality of terminal fittings and the sheet-like flexible conductive member.

(6) Preferably, the terminal fitting includes a connecting portion having an elongated shape, the sheet-like flexible conductive member is formed with a plurality of connection holes, the connecting portions being passed through the connection holes, and the connecting portions are fixed to the sheet-like flexible conductive member by soldering portions. According to this configuration, since the connecting portions are positioned with respect to the sheet-like flexible conductive member by the connection holes, the plurality of terminal fittings and the sheet-like flexible conductive member can be fixed in a proper positional relationship.

(7) Preferably, in (6), the plurality of terminal fittings include a plurality of first terminal fittings and a plurality of second terminal fittings having terminal body portions of a common form and the connecting portions having different extending lengths from the terminal body portions, the positioning portion alternately aligns and positions the plurality of first terminal fittings and the plurality of second terminal fittings such that the terminal body portions are arranged in a row, and the plurality of connection holes are arranged in a staggered manner. According to this configuration, pitches between the soldering portions of the adjacent connecting portions can be made wider than pitches between the adjacent first and second terminal fittings. In this way, even if the pitches between the adjacent first and second terminal fittings are narrow, a short circuit between the adjacent soldering portions can be prevented.

### Details of Embodiment of Present Disclosure

### Embodiment

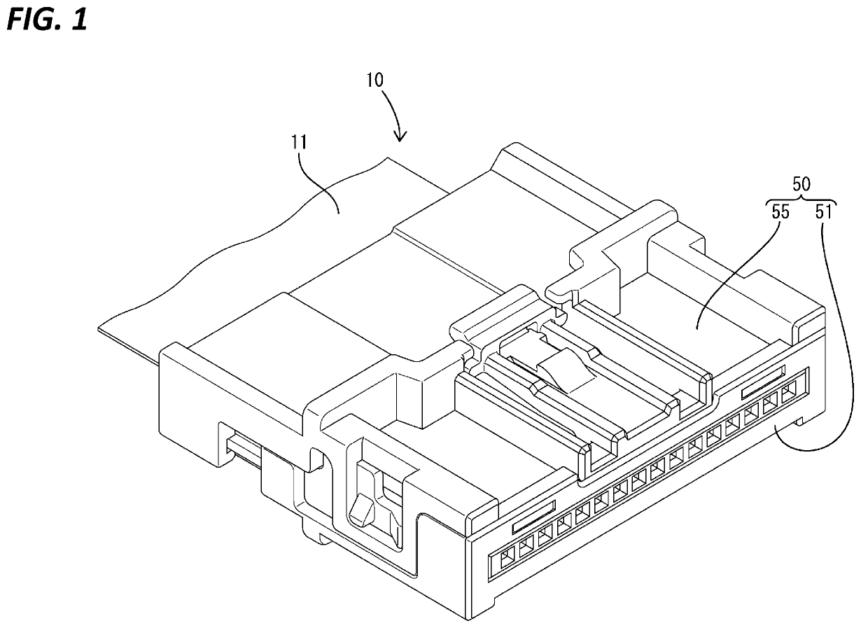

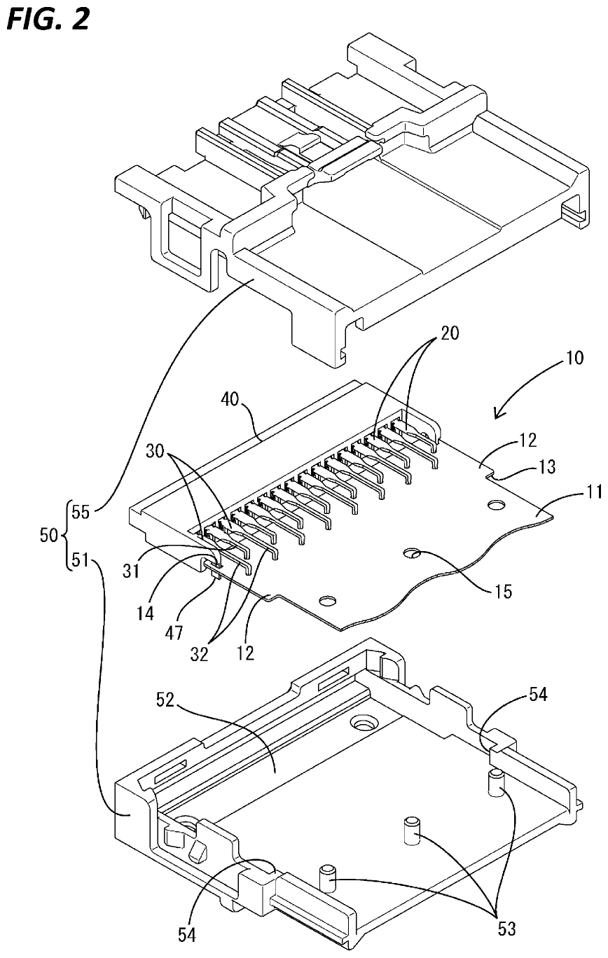

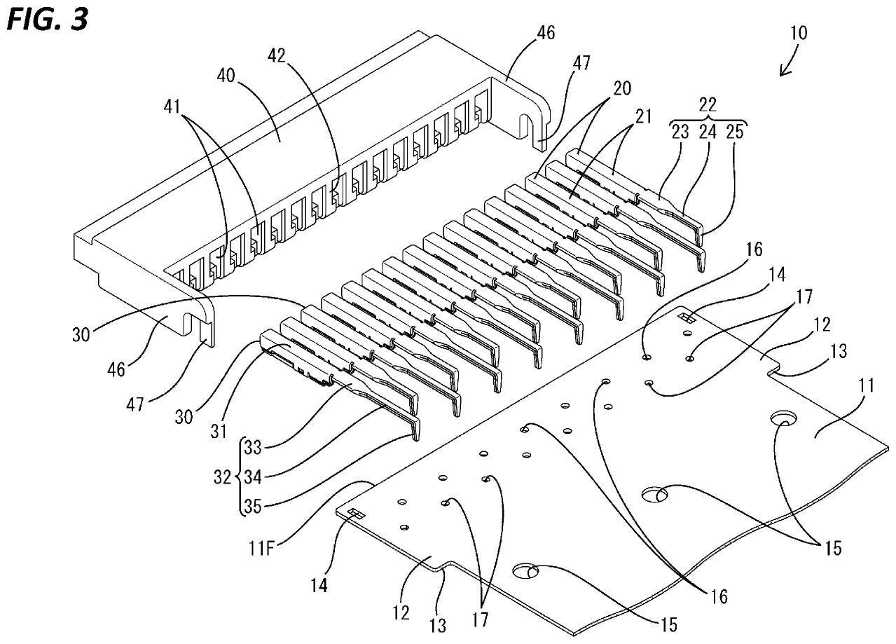

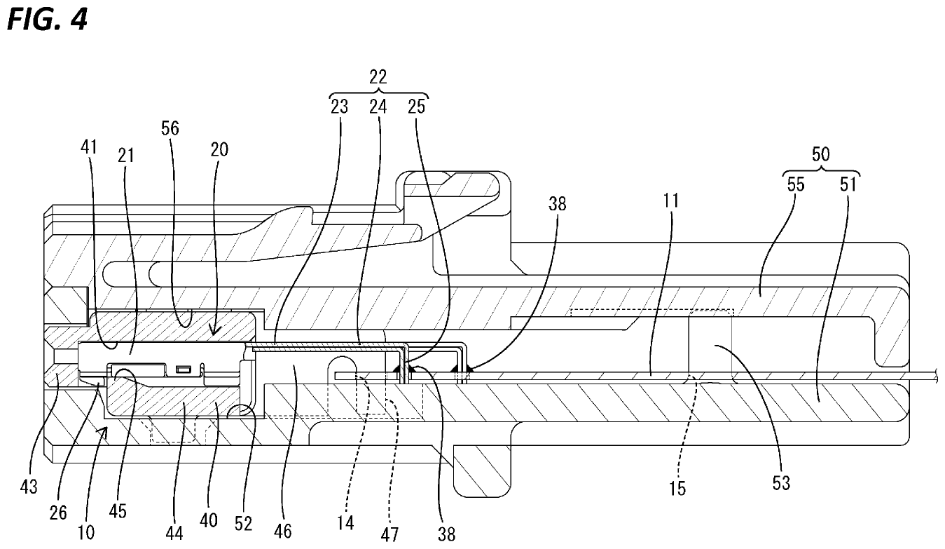

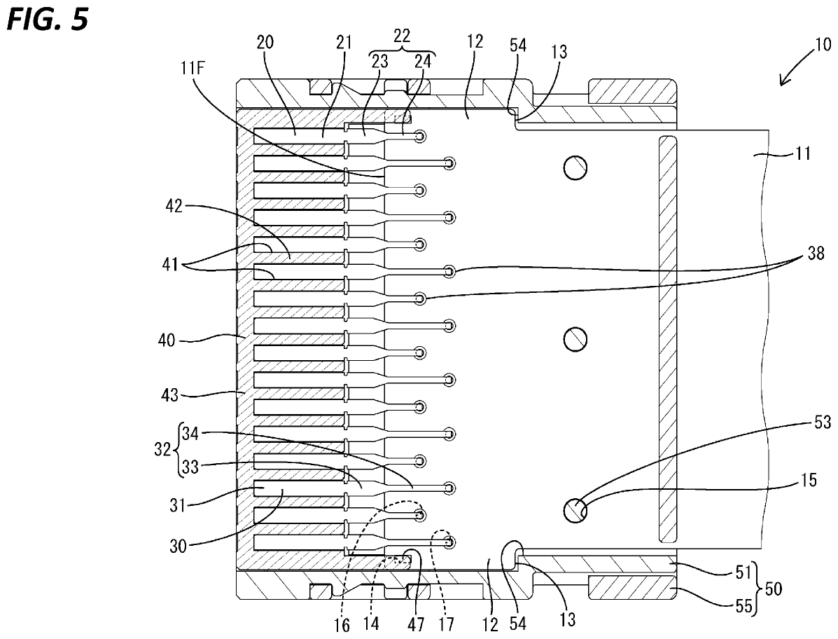

One specific embodiment of a sheet-like conductive path of the present disclosure is described with reference to FIGS. 1 to 5. Note that the present invention is not limited to these illustrations, but is represented by claims and intended to include all changes in the scope of claims and in the meaning and scope of equivalents. In this embodiment, an oblique right-lower side in FIG. 1, an oblique left-upper side in FIGS. 2 and 3 and a left side in FIGS. 4 and 5 are defined as a front side concerning a front-rear direction. Upper and lower sides shown in FIGS. 1 to 4 are directly defined as upper and lower sides concerning a vertical direction. Lower and upper sides in FIG. 5 are defined as left and right sides concerning a lateral direction.

The sheet-like conductive path of this embodiment is, as shown in FIGS. 1, 2 and 4, configured by assembling a conductive path module 10 and a housing 50. As shown in FIG. 2, the conductive path module 10 is configured by assembling one sheet-like flexible conductive member 11, a plurality of first terminal fittings 20, a plurality of second terminal fittings 30 and a holding member 40.

The sheet-like flexible conductive member 11 is constituted by a flexible printed circuit board, a flexible flat cable or the like. The sheet-like flexible conductive member 11 is configured such that printed circuits (not shown) and conductors (not shown) are arranged in a flexible sheet-like base material made of an insulating material. The sheet-like flexible conductive member 11 is horizontally arranged with a thickness direction aligned with the vertical direction.

The sheet-like flexible conductive member 11 is strip-like and extends long in the front-rear direction. As shown in FIGS. 3 and 5, the sheet-like flexible conductive member 11 linearly extends in the lateral direction. A front end part of the sheet-like flexible conductive member 11 is formed with a pair of bilaterally symmetrical bulging portions 12 bulging toward both left and right sides. Rear end parts of the bulging portions 12 are formed with step-shaped retreat restricting portions 13.

Locking holes 14 vertically penetrating through the sheet-like flexible conductive member 11 are formed in front end parts of both left and right retreat restricting portions 13. In a plan view of the sheet-like flexible conductive member 11 from above, the locking hole 14 has a rectangular shape having long sides extending in the front-rear direction. A plurality of (three in this embodiment) positioning holes 15 laterally spaced apart are formed in a region of the sheet-like flexible conductive member 11 behind the locking holes 14.

As many first connection holes 16 as the first terminal fittings 20 and as many second connection holes 17 as the second terminal fittings 30 are formed in a front end part of the sheet-like flexible conductive member 11. The printed circuits or conductors are partially exposed in hole edge parts of the first connection holes 16 and hole edge parts of the second connection holes 17. The first and second connection holes 16, 17 vertically penetrate through the sheet-like flexible conductive member 11. In a plan view, the first and second connection holes 16, 17 are arranged in a staggered manner. A plurality of the first connection holes 16 are arranged in a row at regular intervals in the lateral direction in parallel to a front end edge 11F of the sheet-like flexible conductive member 11. A plurality of the second connection holes 17 are arranged in a row at regular intervals in the lateral direction behind the first connection holes 16. In the lateral direction, the first and second connection holes 16, 17 are alternately arranged at regular pitches.

As shown in FIGS. 3 and 4, the first terminal fitting 20 is a single component including a first terminal body portion 21 in the form of a rectangular tube elongated in the front-rear direction and a first connecting portion 22 extending rearward from the rear end of the first terminal body portion 21. A mating terminal provided in an unillustrated mating connector is inserted from front and connected to the first terminal body portion 21. A front end part of the first connecting portion 22 is formed with a first wide portion 23 having the same width as the first terminal body portion 21. The first connecting portion 22 includes an elongated first extending portion 24 narrower than the first wide portion 23 and extending rearward from the rear end of the first wide portion 23. The first connecting portion 22 includes a first inserting portion 25 bent downward (in a direction toward the sheet-like flexible conductive member 11) from the rear end of the first extending portion 24.

As shown in FIG. 3, the second terminal fitting 30 is a single component including a second terminal body portion 31 in the form of a rectangular tube elongated in the front-rear direction and a second connecting portion 32 extending rearward from the rear end of the second terminal body portion 31. A mating terminal provided in the unillustrated mating connector is inserted from front and connected to the second terminal body portion 31. A front end part of the second connecting portion 32 is formed with a second wide portion 33 having the same width as the first terminal body portion 21. The second connecting portion 32 includes an elongated second extending portion 34 narrower than the second wide portion 33 and extending rearward from the rear end of the second wide portion 33. The second connecting portion 32 includes a second inserting portion 35 bent downward (in the direction toward the sheet-like flexible conductive member 11) from the rear end of the second extending portion 34.

The first and second terminal body portions 21, 31 are parts having the same shape and size. The first and second wide portions 23, 33 are also parts having the same shape and size. The first and second inserting portions 25, 35 are parts having the same shape and size. A length of the first extending portion 24 is shorter than that of the second extending portion 34 by a dimension equal to an interval in the front-rear direction between the first and second connection holes 16, 17. That is, the first and second terminal fittings 20, 30 have the same shape and size except that the lengths of the first and second extending portions 24, 34 are different.

The holding member 40 is a single component made of a synthetic resin material. A heat resistant temperature (melting point) of the holding member 40 is a temperature higher than a temperature in a reflow furnace (not shown) when reflow soldering is performed. Liquid crystal polymer (LCP) having a deflection temperature under load of 260° C. or more can be used as a specific example of a material of the holding member 40. As shown in FIGS. 3 to 5, a plurality of positioning portions 41 are formed side by side in the lateral direction inside the holding member 40. The positioning portions 41 are elongated in the front-rear direction and in the form of through holes open in the front and rear surfaces of the holding member 40. The laterally adjacent positioning portions 41 are partitioned by partition wall portions 42. An arrangement pitch in the lateral direction of the positioning portions 41 is the same as the pitch between the laterally adjacent first and second connection holes 16, 17.

The first terminal fitting 20 or second terminal fitting 30 is inserted into each positioning portion 41 from behind the holding member 40. As shown in FIGS. 4 and 5, each positioning portion 41 includes a front wall portion 43 constituting the front end surface of the holding member 40. The first or second terminal fitting 20, 30 inserted into the positioning portion 41 is positioned with a relative forward movement with respect to the holding member 40 restricted by butting against the front wall portion 43. As shown in FIG. 4, a bottom wall portion 44 constituting each positioning portion 41 is formed with a projection-like retaining portion 45. A relative rearward displacement of the first or second terminal fitting 20, 30 inserted into the positioning portion 41 with respect to the holding member 40 is restricted by locking a locking projection 26 formed on the terminal body portion 21, 31 to the retaining portion 45.

The first and second terminal body portions 21, 31 are accommodated in the positioning portions 41 and the first and second connecting portions 22, 32 are exposed rearwardly of the holding member 40 (positioning portions 41). The first terminal fitting 20 in the positioning portion 41 is positioned in the lateral direction by having the first terminal body portion 21 sandwiched between the partition wall portions 42. The second terminal fitting 30 in the positioning portion 41 is positioned in the lateral direction by having the second terminal body portion 31 sandwiched between the partition wall portions 42. A plurality of the positioned first and second terminal fittings 20, 30 are positioned in the lateral direction at the same pitches as those between the laterally adjacent positioning portions 41 and those between the laterally adjacent first and second connection holes 16, 17. All the first and second terminal fittings 20, 30 are positioned in the lateral direction with respect to the holding member 40. The first and second terminal fittings 20, 30 in the positioning portions 41 are positioned in the vertical direction with respect to the holding member 40 by being sandwiched by the upper and lower surfaces of the positioning portions 41.

As shown in FIGS. 3 and 4, the holding member 40 is formed with a pair of bilaterally symmetrical arm portions 46. The arm portions 46 are cantilevered rearward from both left and right end parts of the holding member 40. Locking portions 47 projecting downward are formed on rear end parts (extending end parts) of the both arm portions 46.

As shown in FIGS. 1, 2 and 4, the housing 50 is configured by vertically stacking a lower housing 51 and an upper housing 55. The lower housing 51 and the upper housing 55 are made of a synthetic resin material having a lower deflection temperature under load than the holding member 40. Polybutylene terephthalate (PBT) can be used as an example of a material of the housing 50.

As shown in FIGS. 2 and 4, a lower recess 52 is formed in a front end part of the upper surface of the lower housing 51. The lower recess 52 positions the holding member 40 in the front-rear direction and lateral direction by accommodating a part of a lower surface side of the holding member 40. A region behind the lower recess 52, out of the upper surface of the lower housing 51, is formed with a plurality of (three in this embodiment) positioning protrusions 53 spaced apart in the lateral direction. A pair of left and right stoppers 54 in the form of steps in a plan view are formed on the inner surfaces of side wall portions of the lower housing 51. An upper recess 56 is formed in a front end part of the lower surface of the upper housing 55. The upper recess 56 positions the holding member 40 in the front-rear direction and lateral direction by accommodating a part of an upper surface side of the holding member 40.

Next, a manufacturing procedure of the sheet-like conductive path is described. First, the first and second terminal fittings 20, 30 are inserted into the positioning portions 41 from behind the holding member 40 and retained by the retaining portions 45. The first terminal fittings 20 are inserted into the positioning portions 41 arranged at the same positions as the first connection holes 16 of the sheet-like flexible conductive member 11 in the lateral direction. The second terminal fittings 30 are inserted into the positioning portions 41 arranged at the same positions as the second connection holes 17 in the lateral direction. That is, the first and second terminal fittings 20, 30 are inserted into the positioning portions 41 to be alternately arranged in the lateral direction. The plurality of first and second terminal fittings 20, 30 inserted into the positioning portions 41 are positioned with respect to each other in the lateral direction and, at the same time, also positioned with respect to the holding member 40 in the lateral direction.

Thereafter, the holding member 40 and the first and second terminal fittings 20, 30 are brought closer to the front end part of the sheet-like flexible conductive member 11, and the locking portions 47 of the holding member 40 are fit into the locking holes 14 of the sheet-like flexible conductive member 11. The first inserting portions 25 of the first connecting portions 22 are fit into the first connection holes 16, and the second inserting portions 35 of the second connecting portions 32 are fit into the second connection holes 17. By the fitting of these at a plurality of positions, the holding member 40 and the sheet-like flexible conductive member 11 are positioned in the front-rear direction and lateral direction, and the first and second terminal fittings 20, 30 are positioned in the front-rear direction and lateral direction with respect to the sheet-like flexible conductive member 11.

The conductive path module 10 set in a temporarily assembled state in the above way is accommodated into the reflow furnace (not shown). Solder paste (not shown) is applied to the sheet-like flexible conductive member 11 along the hole edge parts of the first connection holes 16 and the hole edge parts of the second connection holes 17. By heating and melting the solder paste in the reflow furnace, the first connecting portion 22 is connected to the printed circuit or conductor in the hole edge part of the first connection hole 16, and the second connecting portion 32 is connected to the printed circuit or conductor in the hole edge part of the second connection hole 17. When the solder paste in the melted state is solidified to become soldering portions 38 (see FIGS. 4 and 5) after a cooling process, the first terminal fittings 20 (first connecting portions 22) and the second terminal fittings 30 (second connecting portions 32) are conductively fixed to the sheet-like flexible conductive member 11. In the above way, the manufacturing of the conductive path module 10 is completed.

Thereafter, the conductive path module 10 is temporarily assembled with the lower housing 51. At this time, the holding member 40 is accommodated into the lower recess 52, the positioning holes 15 of the sheet-like flexible conductive member 11 are fit to the positioning protrusions 53 of the lower housing 51, and the retreat restricting portions 13 of the bulging portions 12 are locked to the stoppers 54 of the lower housing 51 from front. Subsequently, the upper housing 55 is united with the lower housing 51 by being put on the conductive path module 10, whereby the housing 50 is configured. The holding member 40 is positioned in the front-rear direction and lateral direction with respect to the housing 50 by being fit into the lower recess 52 and the upper recess 56. The sheet-like flexible conductive member 11 is held with a relative rearward displacement with respect to the housing 50 restricted by locking the bulging portions 12 to the stoppers 54.

The entire holding member 40, the entire first terminal fittings 20, the entire second terminal fittings 30 and the front end part of the sheet-like flexible conductive member 11 are accommodated inside the housing 50. The soldering portions 38 (connecting parts of the first connection holes 22 and the first connection holes 16), which are fixing portions of the first terminal fittings 20 and the sheet-like flexible conductive member 11, are also accommodated in the housing 50. The soldering portions 38 (connecting parts of the second connection holes 32 and the first connection holes 16), which are fixing portions of the second terminal fittings 30 and the sheet-like flexible conductive member 11, are also accommodated in the housing 50.

The sheet-like conductive path of this embodiment is provided with the plurality of first terminal fittings 20, the plurality of second terminal fittings 30, the sheet-like flexible conductive member 11, the positioning portions 41 and the housing 50. The plurality of first terminal fittings 20 and the plurality of second terminal fittings 30 are fixed to the sheet-like flexible conductive member 11. The plurality of positioning portions 41 position the plurality of first terminal fittings 20 and the plurality of second terminal fittings 30 in the front-rear direction, vertical direction and lateral direction in a state where the first and second terminal fittings 20, 30 are not fixed to the sheet-like flexible conductive member 11. The plurality of first terminal fittings 20 and the plurality of second terminal fittings 30 fixed to the sheet-like flexible conductive member 11 are accommodated in the housing 50.

The sheet-like conductive path of this embodiment is provided with the positioning portions 41. The positioning portions 41 position the plurality of first terminal fittings 20 and the plurality of second terminal fittings 30 in a state before being fixed to the sheet-like flexible conductive member 11. The sheet-like conductive path of this embodiment can fix the plurality of first terminal fittings 20 and the plurality of second terminal fittings 30 in the positioned state to the sheet-like flexible conductive member 11 by including the positioning portions 41.

The positioning portions 41 can position the plurality of first terminal fittings 20 and the plurality of second terminal fittings 30 in a state where the fixing portions (soldering portions 38) of the plurality of first terminal fittings 20 and the plurality of second terminal fittings 30 to the sheet-like flexible conductive member 11 are exposed. The sheet-like flexible conductive member 11, the plurality of first terminal fittings 20 and the plurality of second terminal fittings 30 are fixed by the soldering portions 38. Therefore, the first terminal fittings 20, the second terminal fittings 30 and the sheet-like flexible conductive member 11 can be fixed by reflow soldering.

The positioning portions 41 are formed in the holding member 40 separate from the housing 50 and made of a material higher in heat resistance than the housing 50. According to this configuration, the plurality of first terminal fittings 20 and the plurality of second terminal fittings 30 positioned by the positioning portions 41 can be fixed to the sheet-like flexible conductive member 11 by reflow soldering. Since the holding member 40 is formed with the locking portions 47 for locking the sheet-like flexible conductive member 11, the plurality of first terminal fittings 20, the plurality of second terminal fittings 30 and the sheet-like flexible conductive member 11 can be positioned via the holding member 40.

Since the fixing portions (soldering portions 38) of the plurality of first terminal fittings 20, the plurality of second terminal fittings 30 and the sheet-like flexible conductive member 11 are accommodated in the housing 50, the interference of an external matter with the soldering portions 38 can be prevented.

The first terminal fitting 20 includes the first connecting portion 22 having an elongated shape, and the second terminal fitting 30 includes the second connecting portion 32 having an elongated shape. The sheet-like flexible conductive member 11 is formed with the plurality of first connection holes 16, through which the plurality of first connecting portions 22 are individually passed, and the plurality of second connection holes 17, through which the plurality of second connecting portions 32 are individually passed. The first and second connecting portions 22, 32 are fixed to the sheet-like flexible conductive member 11 by the soldering portions 38. The first connecting portions 22 are positioned with respect to the sheet-like flexible conductive member 11 by the first connection holes 16, and the second connecting portions 32 are positioned with respect to the sheet-like flexible conductive member 11 by the second connection holes 17. By this positioning, the plurality of first terminal fittings 20, the plurality of second terminal fittings 30 and the sheet-like flexible conductive member 11 can be fixed in a proper positional relationship.

The plurality of terminal fittings fixed to the sheet-like flexible conductive member 11 include the plurality of first terminal fittings 20 and the plurality of second terminal fittings 30 having the terminal body portions 21, 31 of a common form. An extending length of the first connecting portion 22 from the first terminal body portion 21 of the first terminal fitting 20 and that of the second connecting portion 32 from the second terminal body portion 31 of the second terminal fitting 30 are different. The positioning portions 41 alternately align and position the plurality of first terminal fittings 20 and the plurality of second terminal fittings 30 such that the first and second terminal body portions 21, 31 are arranged in a row. The plurality of first connection holes 16 and the plurality of second connection holes 17 are arranged in a staggered manner.

As shown in FIG. 5, an arrangement direction of the soldering portions 38 of the adjacent first connecting portions 22 and the soldering portions 38 of the second connecting portions 32 is a direction oblique to both the front-rear direction and lateral direction. Pitches in the oblique direction (shortest pitches) between the adjacent soldering portions 38 of the first connecting portion 22 and those of the second connecting portion 32 are wider than the pitches in the lateral direction between the adjacent first and second terminal fittings 20, 30. In this way, a short circuit between the adjacent soldering portions 38 can be prevented even if the pitches in the lateral direction between the adjacent first terminal fittings 20 (first terminal body portions 21) and second terminal fittings 30 (second terminal body portions 31) are narrow.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although the sheet-like flexible conductive member, the first terminal fittings and the second terminal fittings are fixed by the soldering portions in the above embodiment, the sheet-like flexible conductive member, the first terminal fittings and the second terminal fittings may be fixed by means other than the soldering portion.

Although the positioning portions are formed in the component (positioning member) separate from the housing in the above embodiment, the positioning member may be integrally formed to the housing.

Although the holding member is formed with the locking portions for locking the sheet-like flexible conductive member in the above embodiment, the holding member may not include the locking portions.

Although the fixing portions of the plurality of first and second terminal fittings and the sheet-like flexible conductive member are accommodated in the housing in the above embodiment, the fixing portions of the plurality of first and second terminal fittings and the sheet-like flexible conductive member may be exposed to the outside of the housing.

Although the first and second connecting portions formed in the first and second terminal fittings are passed through the first and second connection holes of the sheet-like flexible conductive member in the above embodiment, the first and second terminal fittings may be fixed in a surface-mounted form by being placed on the surface of the sheet-like flexible conductive member.

Although the first and second connection holes are arranged in a staggered manner in the above embodiment, the first and second connection holes may be arranged side by side in a row.

### LIST OF REFERENCE NUMERALS

10 . . . conductive path module
11 . . . sheet-like flexible conductive member
11F . . . front end edge of sheet-like flexible conductive member
12 . . . bulging portion
13 . . . retreat restricting portion
14 . . . locking hole
15 . . . positioning hole
16 . . . first connection hole (connection hole)
17 . . . second connection hole (connection hole)
20 . . . first terminal fitting (terminal fitting)
21 . . . first terminal body portion
22 . . . first connecting portion
23 . . . first wide portion
24 . . . first extending portion
25 . . . first inserting portion
26 . . . locking projection
30 . . . second terminal fitting (terminal fitting)
31 . . . second terminal body portion
32 . . . second connecting portion
33 . . . second wide portion
34 . . . second extending portion
35 . . . second inserting portion
38 . . . soldering portion
40 . . . holding member
41 . . . positioning portion
42 . . . partition wall portion
43 . . . front wall portion
44 . . . bottom wall portion
45 . . . retaining portion
46 . . . arm portion
47 . . . locking portion
50 . . . housing
51 . . . lower housing
52 . . . lower recess
53 . . . positioning protrusion
54 . . . stopper
55 . . . upper housing
56 . . . upper recess

1. A sheet-like conductive path, comprising:
a plurality of terminal fittings;
a sheet-like flexible conductive member to be fixed to the plurality of terminal fittings;
a positioning portion for positioning the plurality of terminal fittings in a state where the plurality of terminal fittings are not fixed to the sheet-like flexible conductive member; and
a housing for accommodating the plurality of terminal fittings fixed to the sheet-like flexible conductive member,
the positioning portion being formed in a holding member separate from the housing,
the holding member being accommodated in the housing,
a positioning hole formed in the sheet-like flexible conductive member being fit to a positioning protrusion formed in the housing,
the terminal fitting including a connecting portion having an elongated shape,
the sheet-like flexible conductive member being formed with a plurality of connection holes, the connecting portions being passed through the connection holes, and
the connecting portions are fixed to the sheet-like flexible conductive member by soldering portions.

2. The sheet-like conductive path of claim 1, wherein:
the positioning portion is capable of positioning the plurality of terminal fittings with fixing portions of the plurality of terminal fittings to the sheet-like flexible conductive member exposed, and
the sheet-like flexible conductive member and the plurality of terminal fittings are fixed by soldering portions.

3. The sheet-like conductive path of claim 1, wherein the positioning portion is formed in the holding member made of a material higher in heat resistance than the housing.

4. The sheet-like conductive path of claim 1, wherein the holding member is formed with a locking portion for locking the sheet-like flexible conductive member.

5. The sheet-like conductive path of claim 1, wherein fixing portions of the plurality of terminal fittings and the sheet-like flexible conductive member are accommodated in the housing.

6. (canceled)

7. The sheet-like conductive path of claim 1, wherein:
the plurality of terminal fittings include a plurality of first terminal fittings and a plurality of second terminal fittings having terminal body portions of a common form and the connecting portions having different extending lengths from the terminal body portions,
the positioning portion alternately aligns and positions the plurality of first terminal fittings and the plurality of second terminal fittings such that the terminal body portions are arranged in a row, and
the plurality of connection holes are arranged in a staggered manner.
